(19) United States
(12) Patent Application Publication
(10) Pub. No.: US 2026/0186174 A1
(43) Pub. Date: Jul. 2, 2026

(54) CONVEX-CONCAVE FRESNEL LENS

(71) Applicant: HELLA GMBH & CO. KGAA, Lippstadt (DE)

(72) Inventors: Gerhard Kloos, Erwitte (DE); Philip Stroop, Schloß Holte-Stukenbrock (DE); Benjamin Willeke, Paderborn (DE); Rimma Zhytnytska, Lippstadt (DE)

(21) Appl. No.: 19/549,787

(22) Filed: Feb. 25, 2026

Related U.S. Application Data
(63) Continuation of application No. PCT/EP2023/074014, filed on Sep. 1, 2023.

(51) Int. Cl. G02B 3/08; B60Q 1/04; G02B 1/04

(52) U.S. Cl. CPC G02B 3/08; B60Q 1/04; G02B 1/041

(57) ABSTRACT

A convex-concave Fresnel-lens for a lighting unit of a vehicle is provided. The convex-concave Fresnel-lens includes a convex input surface and a concave output surface. The concave output surface includes a Fresnel structure. The concave output surface has a first radius of curvature, and the convex input surface has a second radius of curvature. The convex input surface is configured to be oriented towards a light source of the lighting unit.

### CROSS-REFERENCE TO RELATED APPLICATIONS

This application is a continuation of PCT/EP2023/074014, filed Sep. 1, 2023, the disclosure of which is incorporated by reference in its entirety.

### FIELD OF THE INVENTION

The present invention relates to the field of lens for a lighting unit of a vehicle. Furthermore, the invention relates to a convex-concave Fresnel-lens for a lighting unit of a vehicle, a lighting unit with such a lens, a vehicle and a use of such a lens in a lighting unit of a vehicle.

### BACKGROUND OF THE INVENTION

While different lenses may be used for a lighting unit of a vehicle, they all have to satisfy the legally prescribed maximum glare value. A lens designed for a lighting unit of a vehicle should hence ensure sufficient mechanical and thermomechanical stability in order to safely remain below said legally prescribed maximum glare value when being in use. In general, lenses designed for a lighting unit have to be tested using a thermal cycling test, whereas the glare value should remain below the prescribed value after executing said test.

Classical Fresnel projection lenses consist of a planar entrance surface and a planar exit surface, also designated as input and output surfaces, wherein into the planar exit surface a Fresnel structure is introduced. However, it has been found that latter design does not seem to be appropriate in view of the thermoelastic stability for a lens made of plastic and designed to be used for a lighting unit of a vehicle.

Accordingly, it may be desirable to provide for an improved Fresnel-lens for a lighting unit with improved mechanical and thermoelastic stability, even after having been submit to a thermal cycling test. It may also be desirable to provide an improved Fresnel-lens for a lighting unit with high imaging quality.

### SUMMARY OF THE INVENTION

According to a first aspect of the present disclosure, the problem is solved by a convex-concave Fresnel-lens for a lighting unit of a vehicle. The convex-concave Fresnel-lens comprises a convex input surface and a concave output surface. The concave output surface comprises a Fresnel structure. The concave output surface has a first radius of curvature and the convex input surface has a second radius of curvature. The convex input surface is configured to be oriented towards a light source of the lighting unit.

In other words, the provided Fresnel-lens deviates from conventional Fresnel-lenses in being designed as a meniscus lens, wherein the Fresnel structure is on the curved output surface of the lens. Hence, the provided Fresnel-lens may be designated as a bowl-shaped Fresnel-lens, as the Fresnel-structure is visible from the point of view of an observer. A major advantage of this design or shape compared to the shapes commonly used for Fresnel-lenses is that the lens behaves more stably with respect to mechanical stresses. Latter design of the lens further allows improving the robustness of the lens when being submitted to a thermal cycling test. During a thermal cycling test, the temperature may vary between −40° C. to +100° C. Hence, the glare value of the provided Fresnel-lens can easily satisfy the legally prescribed glare value.

An additional major advantage of this design or shape compared to the shapes commonly used for Fresnel-lenses is that having the Fresnel-structure on the output surface allows improving the imaging quality of the lens. It has been found out that the light distribution of the provided Fresnel-lens has a sharp cutoff line.

The lighting unit of the vehicle can be any unit placed outside or inside the vehicle. The lighting unit may for example designate a headlight such as a low beam, a high beam, a front light or the like.

According to an embodiment of the convex-concave Fresnel-lens, the first radius of curvature and the second radius of curvature are identical.

It is noted that the term identical includes the usual margin of error in the manufacturing of such a lens.

According to an embodiment of the convex-concave Fresnel-lens, the first radius of curvature is bigger than the second radius of curvature.

According to an embodiment of the convex-concave Fresnel-lens, the Fresnel structure of the concave output surface comprises a plurality of sloped facets and a plurality of concentric draft facets, wherein each pair of sloped facet and draft facet forms a Fresnel section. The sloped facets are curved or straight.

According to an embodiment of the convex-concave Fresnel-lens, the Fresnel structure of the concave output surface covers at least 80% of the concave output surface, in particular all the convex output surface. The Fresnel structure is a repetition of concentric Fresnel sections disposed relative to the center of the convex-concave Fresnel-lens.

According to an embodiment of the convex-concave Fresnel-lens, the first radius of curvature is 380 mm or smaller, in particular between 300 mm and 380 mm.

Such a first radius advantageously allows providing a robust Fresnel-lens for a lighting unit of a vehicle while delivering a rather flat aspect of the lens. Indeed, in the field of lighting unit for vehicles it might be preferable to provide a lens being recognizable as almost flat by the human's eye. A first radius of curvature of 380 mm may be particularly advantageous as being a good compromise between robustness and “flatness” of the lens. It is noted that a rather “flat” lens may be easily arranged in a lighting unit as it takes less space in depth as a drastically curved lens.

According to an embodiment of the convex-concave Fresnel-lens, the convex-concave Fresnel-lens has an average thickness and/or a maximal thickness between 3 to 7 mm, in particular of 3 mm.

Latter thickness range may allow providing a lens which is easily manufacturable.

According to an embodiment of the convex-concave Fresnel-lens, the convex-concave Fresnel-lens is made of plastic, in particular of PMMA or of polycarbonate.

According to a second aspect of the present disclosure, a lighting unit for a vehicle comprising at least one convex-concave Fresnel-lens as described hereinabove and hereinafter is provided.

According to a third aspect of the present disclosure, a vehicle comprising a lighting unit as described hereinabove is provided.

According to a fourth aspect of the present disclosure, a use of a concave-convex Fresnel-lens as described hereinabove and hereinafter in a lighting unit of a vehicle is provided.

Generally, any feature, function, element and/or advantage which is described hereinabove and hereinbelow with reference to one aspect of the present disclosure, equally applies to any other aspect of the disclosure as described above and in the following.

Particularly, unless explicitly stated otherwise, features, functions, elements, and/or advantages as described above and in the following with reference to the system equally apply to the convex-concave Fresnel-lens, the lighting unit and/or to the vehicle as described hereinabove and in the following and vice versa.

### BRIEF DESCRIPTION OF THE DRAWING

The aforementioned and other features and advantages of the invention will become further apparent from the following detailed description read in conjunction with the accompanying drawings, in which:

FIG. 1 shows a cross section of a convex-concave Fresnel-lens according to an exemplary embodiment;

FIG. 2 shows in a front view a convex-concave Fresnel-lens according to an exemplary embodiment; and

FIG. 3 shows a vehicle according to an exemplary embodiment.

The figures are schematic only and not true to scale. In principle, identical or like parts and/or elements are provided with identical or like reference numerals in the figures.

### DETAILED DESCRIPTION OF THE CURRENT EMBODIMENT

While specific embodiments are disclosed hereinafter, various changes and modifications can be made without departing from the scope of the invention. The present embodiments are to be considered in all respects as illustrative and non-restrictive, and all changes coming within the meaning and equivalency range of the appended claims are intended to be embraced therein.

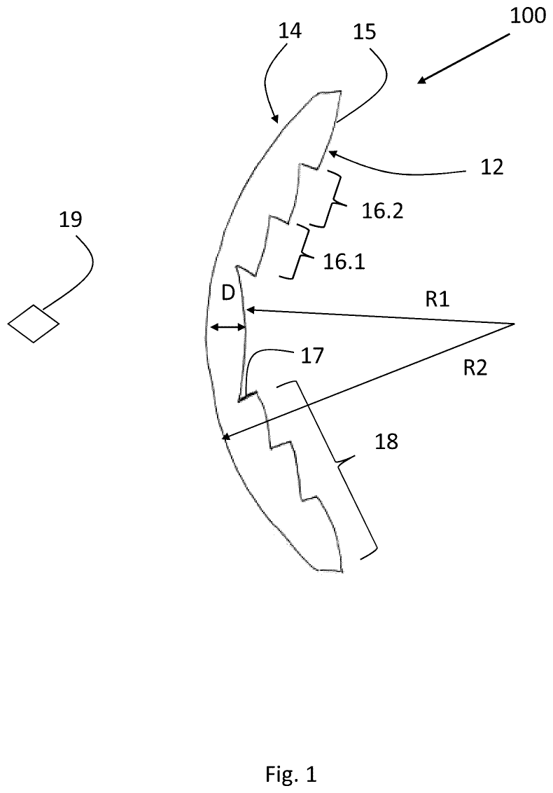

FIG. 1 shows a cross section of a convex-concave Fresnel-lens 100 according to an exemplary embodiment. The convex-concave Fresnel-lens 100 of FIG. 1 may for example be round. Other base-shapes of the lens such as rectangular shapes are also possible. The lens 100 of FIG. 1 comprises a convex input surface 14 and a concave output surface 12. The concave output surface 12 comprises a Fresnel structure 18. The concave output surface 12 has a first radius of curvature R1 and the convex input surface 14 has a second radius of curvature R2. The convex input surface 14 is configured to be oriented towards a light source 19 of the lighting unit 22.

In FIG. 1, the first radius of curvature R1 may be slightly bigger than the second radius of curvature R2. Hence, the lens of FIG. 1 may be designated as a positive meniscus Fresnel-lens. Although in FIG. 1 the Fresnel structure 18 does not cover the whole surface of the concave output surface 12, it may be preferable that the Fresnel structure 18 covers 100% of the concave output surface 12 of the lens. The Fresnel structure 18 is concentric and hence inevitably symmetric when seen from a cross sectional view, as shown in FIG. 1. The Fresnel structure 18 comprises a repetition of Fresnel section 16.1, 16.2, whereas each section comprises a sloped facet 15 and a draft facet 17. It is noted that the Fresnel section 16.1, 16.2 may be all identical or may differ in height and width S.

For styling reasons, lenses for lighting units 22 may be as flat as possible while ensuring a certain robustness, in particular robustness against temperature cycling testing. Further, a certain stability under mechanical loads, such as mechanical stresses caused by clamping in the holding geometry, must be ensured. This is achieved with a lens as described with reference to FIG. 1. The lens 100 of FIG. 1 may hence have an average thickness D of 3 mm to 7 mm and a first radius of curvature R1 between 300 mm and 380 mm. It is noted that a comparatively high first radius of curvature R1 may be chosen, so that the appearance of the lens is still one of a flat lens.

The thickening of the lens 100 may be achieved by parallel shifting of the convex input surface 14 along the optical axis or by a so-called offset operation along the surface normal of the concave output surface 12.

Extensive series of tests led to the result that the Fresnel-lens 100 constructed as shown in FIG. 1 shows less or no disturbing effect due to for example temperature variations or mechanical stresses in comparison to known Fresnel lenses, i.e. plano-convex Fresnel-lenses. Such a Fresnel-lens allows reducing optical aberrations. The provided lens has an improved imaging quality. The light distribution to be projected in the focal plane is formed by primary optics.

Summarizing, a significant advantage of this shape of the lens 100 of FIG. 1 compared to the shapes commonly used for Fresnel-lenses 100 is that a high imaging quality can be achieved with the novel lens 100. Furthermore, this Fresnel-lens 100 is more stable with respect to mechanical loads and behaves more robustly under thermal cycling than a planar lens.

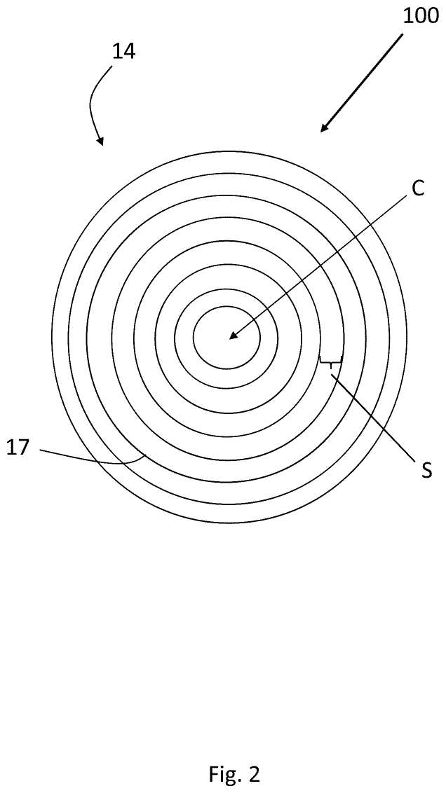

FIG. 2 shows in a front view a convex-concave Fresnel-lens 100 according to an exemplary embodiment. In a front view, the Fresnel sections 16 of the lens are distinguishable as the circles outline the draft facets 17. The width S of the Fresnel section 16 can be defined as the distance between two concentric lines, i.e. between two circles. The lens of FIG. 2 is preferably made of PMMA.

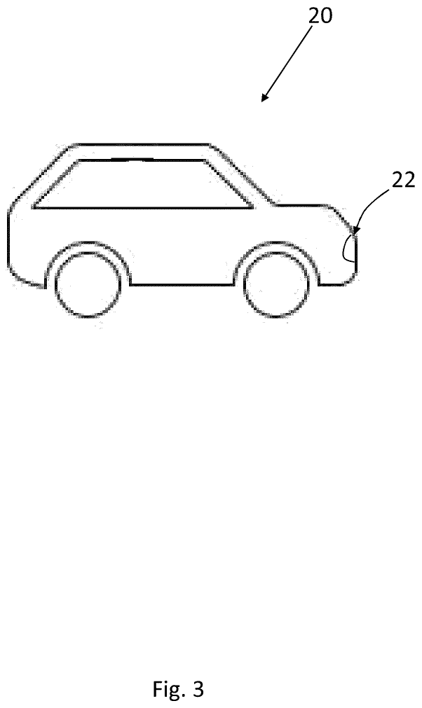

FIG. 3 shows a vehicle 20 according to an exemplary embodiment. The vehicle 20 may have numerous lighting units 22. Each lighting unit 22 may be equipped with a convex-concave Fresnel-lens 100 such as shown in FIG. 1 and/or FIG. 2.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage. Any reference signs in the claims should not be construed as limiting the scope.

### LIST OF REFERENCE SIGNS

100 convex-concave Fresnel-Lens
12 concave output surface
14 convex input surface
15 sloped facet
16 Fresnel section
17 draft facet
18 Fresnel structure
19 Light source
20 vehicle
22 lighting unit
R1 First radius of curvature
R2 Second radius of curvature
D average thickness
S width of Fresnel section
C center of the lens

1. A convex-concave Fresnel lens for a lighting unit of a vehicle, comprising:
a convex input surface and a concave output surface,
wherein the concave output surface comprises a Fresnel structure,
wherein the concave output surface has a first radius of curvature and the convex input surface has a second radius of curvature, and
wherein the convex input surface is configured to be oriented towards a light source of the lighting unit.

2. The convex-concave Fresnel lens of claim 1, wherein the first radius of curvature and the second radius of curvature are identical.

3. The convex-concave Fresnel lens of claim 1, wherein the first radius of curvature is bigger than the second radius of curvature.

4. The convex-concave Fresnel lens of claim 1, wherein the Fresnel structure of the concave output surface comprises a plurality of sloped facets and a plurality of concentric draft facets, wherein each pair of sloped facets and draft facets form a Fresnel section, wherein the sloped facets are curved or straight

5. The convex-concave Fresnel lens of claim 1, wherein:
the Fresnel structure of the concave output surface covers at least 80% of the concave output surface; and
the Fresnel structure is a repetition of concentric Fresnel sections disposed relative to a center of the convex-concave Fresnel-lens.

6. The convex-concave Fresnel lens of claim 1, wherein the first radius of curvature is between 300 mm and 380 mm.

7. The convex-concave Fresnel lens of claim 1, wherein the convex-concave Fresnel-lens has an average thickness or a maximal thickness between 3 to 7 mm.

8. The convex-concave Fresnel lens of claim 1, wherein the convex-concave Fresnel-lens is made of PMMA or polycarbonate.

9. A lighting unit for a vehicle, comprising:
the convex-concave Fresnel lens of claim 1.

10. A vehicle comprising:
The lighting unit of claim 9.
